(19) United States
(12) Patent Application Publication
(10) Pub. No.: US 2026/0303504 A1
(43) Pub. Date: Oct. 1, 2026

(54) EXTENDING END-TO-END MEASUREMENTS TO THE NIC IN AN AI DATA CENTER FABRIC

(71) Applicant: Cisco Technology, Inc., San Jose, CA (US)

(72) Inventors: Clarence Andre M. Filsfils, Uccle (BE); Pablo Camarillo Garvia, Madrid (ES); Ahmed Mohamed Ahmed Abdelsalam, L’Aquila (IT); Carmine Scarpitta, Santa Marina (IT)

(73) Assignee: Cisco Technology, Inc., San Jose, CA (US)

(21) Appl. No.: 19/563,716

(22) Filed: Mar. 11, 2026

Related U.S. Application Data
(60) Provisional application No. 63/777,252, filed on Mar. 25, 2025.
(60) Provisional application No. 63/777,254, filed on Mar. 25, 2025.
(60) Provisional application No. 63/777,257, filed on Mar. 25, 2025.

(51) Int. Cl. H04L 43/12; H04L 45/74

(52) U.S. Cl. CPC H04L 43/12; H04L 45/74

(57) ABSTRACT

In one implementation, a first device in a network fabric generates a probe packet to probe a particular path in the network fabric between the first device and a second device. The first device adds, based on the particular path, a list of segment routing identifiers to the probe packet that includes segment routing identifiers from the first device to the second device and from the second device back to the first device. The first device sends the probe packet with the list of segment routing identifiers towards the second device. The first device uses the probe packet sent via the particular path to determine one or more performance metrics for the particular path.

### RELATED APPLICATIONS

The present disclosure claims priority to U.S. Prov. Appl. Ser. No. 63/777,252, filed on Mar. 25, 2025, entitled “EXTENDING END-TO-END MEASUREMENTS TO THE NIC IN AN AI DATA CENTER FABRIC,” by Filsfils, et al., to U.S. Prov. Appl. Ser. No. 63/777,254, filed on Mar. 25, 2025, entitled “DETERMINISTIC PER-PATH MEASUREMENTS IN A DATA CENTER FABRIC,” by Filsfils, et al., and to U.S. Prov. Appl. Ser. No. 63/777,257, filed on Mar. 25, 2025, entitled “DERIVING ONE-WAY MEASUREMENT FROM TOR-TO-NIC AND NIC-TO-TOR,” by Filsfils, et al., the contents of which are incorporated herein by reference.

### TECHNICAL FIELD

The present disclosure relates generally to network compute fabrics and, more particularly to extending end-to-end measurements to the network interface controller (NIC) in an artificial intelligence (AI) data center fabric.

### BACKGROUND

In modern artificial intelligence (AI) and high-performance computing (HPC), fabric resources are not unlimited. This means that different AI model training and other computing tasks often need to be scheduled, resulting in some of the tasks having to wait for execution. Indeed, recent studies estimate that approximately 33% of the processing time for all AI tasks is attributable to waiting on backend network delays.

Common network implementations for connecting front-end CPU-based networks and backend GPU-based HPC networks to facilitate data transfer and high-performance computing tasks include High-Speed Ethernet, InfiniBand, NVLink, Peripheral Component Interconnect Express (PCIe), and Fibre Channel (FC), among others. When it comes to AI workloads, a front-end network scheduler is typically used to schedule and orchestrate AI-related workloads ranging from model training to inferencing and data processing. This scheduling often entails coordinating various resources and services, managing job queues, and ensuring that the right data and computational resources are available.

However, in current deployments, end-to-end path performance metrics (e.g., latency, liveliness, loss, jitter, etc.) are often lacking in AI fabrics.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example of a user interfacing with an artificial intelligence (AI) model;

FIG. 4 illustrates an example architecture for an AI agent;

FIG. 5 illustrates an example network or compute fabric for performing AI model training and high-performance computing (HPC) tasks; and

FIG. 6 illustrates an example simplified procedure for extending end-to-end measurements to the network interface controller (NIC) in an AI data center fabric, in accordance with one or more implementations described herein.

### DESCRIPTION OF EXAMPLE IMPLEMENTATIONS

### Overview

According to one or more implementations of the disclosure, a first device in a network fabric generates a probe packet to probe a particular path in the network fabric between the first device and a second device. The first device adds, based on the particular path, a list of segment routing identifiers to the probe packet that includes segment routing identifiers from the first device to the second device and from the second device back to the first device. The first device sends the probe packet with the list of segment routing identifiers towards the second device. The first device uses the probe packet sent via the particular path to determine one or more performance metrics for the particular path.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

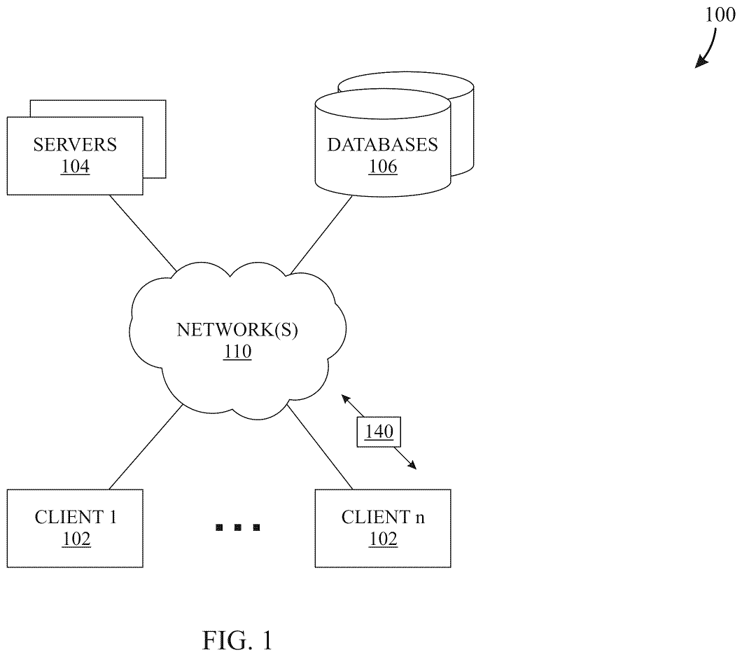

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

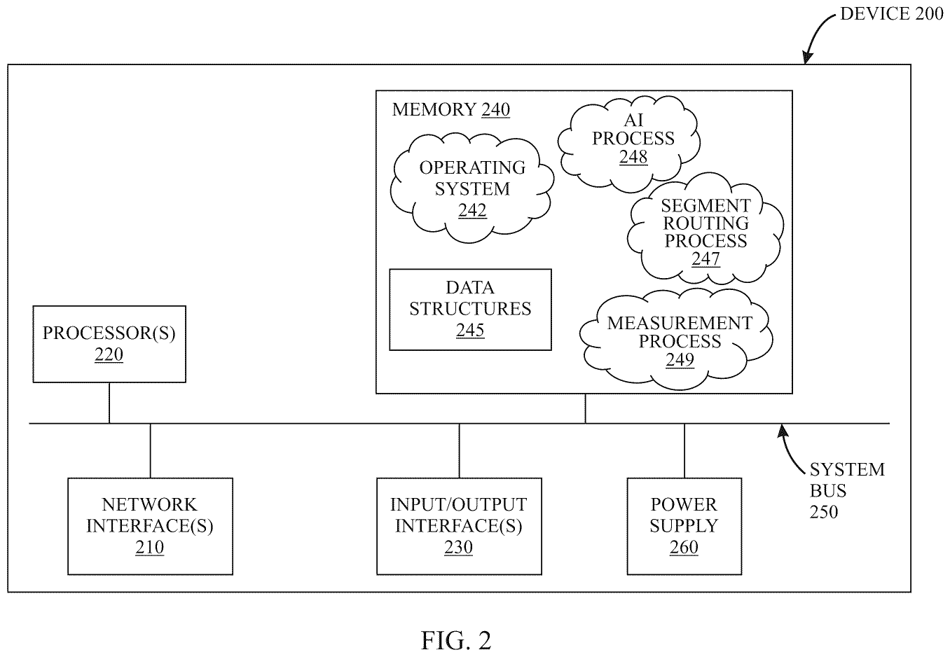

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a segment routing process 247, AI process 248, and/or a measurement process 249, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

Segment routing process 247, AI process 248, and/or measurement process 249 include computer executable instructions executed by processor 220 to perform functions in accordance with one or more routing protocols, such as the Interior Gateway Protocol (IGP) (e.g., Open Shortest Path First, “OSPF,” and Intermediate-System-to-Intermediate-System, “IS-IS”), the Border Gateway Protocol (BGP), etc., as will be understood by those skilled in the art. For instance, these operations may include configuring and managing a forwarding information database containing, e.g., data used to make forwarding decisions. In particular, changes in the network topology may be communicated among devices in the computer network, such as device 200, using a routing protocol, such as the OSPF or IS-IS link-state protocols, to “converge” to an identical view of the network topology.

In various implementations, segment routing process 247, AI process 248, and/or measurement process 249 may cause device 200 to perform segment routing in the network or operate in accordance thereto, such as, e.g., in conjunction with Multiprotocol Label Switching (MPLS). For example, measurement process 249 may utilize extensions to the IGP (e.g., IS-IS, OSPF, etc.), that allow IGP messages to carry MPLS label information, to use segment routing within the network.

In general, segments in a segment routed network may fall into one of two categories: node segments and adjacency segments. Adjacency segments generally represent the local interface between a given node and an adjacent neighbor. Notably, adjacency segments do not need to be unique among the different nodes, as adjacency segments only require local significance to the particular node. Node segments, in contrast, are global in nature and use unique identifiers to represent node segment endpoints. When used in conjunction with MPLS, segments (e.g., node and adjacency segments) may be treated as labels, whereby a node may either “push” a new segment/label onto the stack, “pop” (e.g., remove) the top segment/label from the stack, or “swap” the top label of the stack with another label.

In various implementations, as detailed further below, segment routing process 247, AI process 248, and/or measurement process 249 may include computer executable instructions that, when executed by processor 220, cause device 200 to perform the techniques described herein. To do so, in some implementations, segment routing process 247, AI process 248, and/or measurement process 249 may utilize AI/machine learning. In general, AI/machine learning is concerned with the design and the development of techniques that take as input empirical data (such as network statistics and performance indicators) and recognize complex patterns in these data. One very common pattern among these techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, segment routing process 247, AI process 248, and/or measurement process 249 may use one or more supervised, unsupervised, or semi-supervised AI/machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example AI/machine learning techniques that segment routing process 247, AI process 248, and/or measurement process 249 could use may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, segment routing process 247, AI process 248, and/or measurement process 249 may also use one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of machine unlearning, AI process 248 may be a component of, use, and/or be utilized in the management of prompts/access to a generative model to perform layer attribution, perform layer sensitivity assessment, remove capabilities from a previously trained model, retain model performance, etc. based on a conversational input from a user (e.g., voice, text, etc.). Example generative approaches can include, but are not limited to, generative adversarial networks (GANs), large language models (LLMs) and other foundation models, diffusion models, transformer models, and the like.

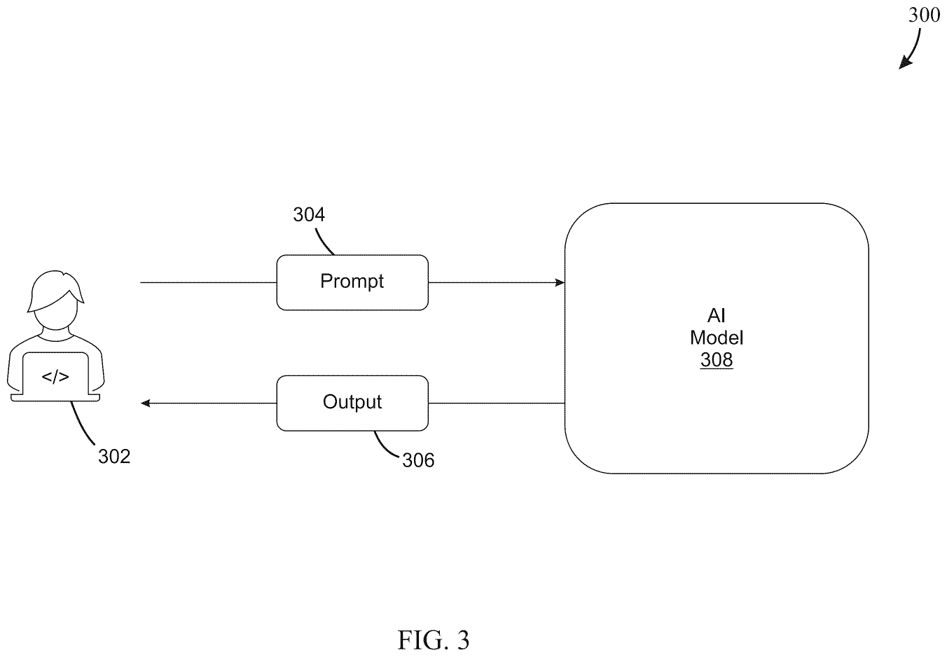

FIG. 3 illustrates an example 300 for interfacing with an AI model, in various implementations. In example 300, a user 302 may send a prompt 304 (e.g., a query, a query augmented with additional data, documents, and/or images, etc.) to an AI model 308. The AI model 308 may be configured to process a prompt 304 to generate an output 306 to satisfy the prompt 304.

AI model 308 may be a model configured to apply its trained algorithms to generate a response (e.g., output 306) based on the prompt 304 provided. More specifically, AI model 308 may be trained on a training dataset 310 and, once trained, be deployed for inference. For instance, in some cases, AI model 308 may take the form of a large language model (LLM) or other foundation model, diffusion-based model, combinations thereof, or the like.

The output 306 may be the result produced by AI model 308 (e.g., by the application of AI model 308 to the prompt 304). This output can vary depending on the model's configuration and the task at hand. For example, the output 306 may include one or more of a generated and/or synthesized image, a text response, a classification and/or prediction, etc.

As would be appreciated, AI agents are also capable of interacting with generative models, such as AI model 308, which may be integrated directly into the agent or accessed via an API. Indeed, the recent breakthroughs in large language models (LLMs), such as GPT-4, as well as other generative models, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

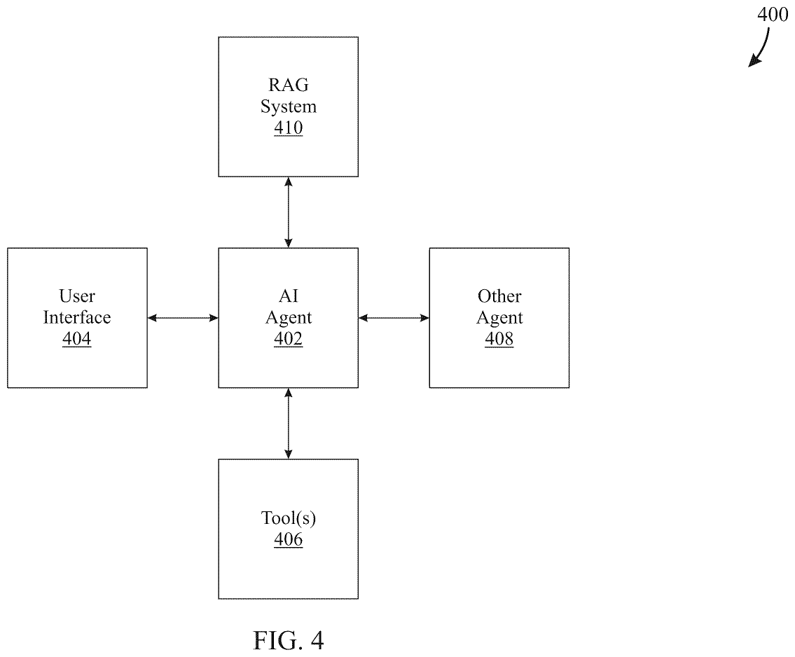

FIG. 4 illustrates an example architecture 400 for an artificial intelligence (AI) agent, according to various implementations. At the core of architecture 400 is AI agent 402, which may be implemented through execution of AI process 248.

As shown, AI agent 402 may interact with a user via a user interface 404. For instance, a user may issue a prompt to AI agent 402 that seeks an answer to a question, performance of a certain task, or the like. In turn, AI agent 402 may use its associated model to formulate a response.

Also as shown, AI agent 402 may interact with tools 406. In general, tools 406 may take the form of interfaces that allow AI agent 402 to interact with any number of systems, in its efforts to produce a response for its input request. For instance, tools 406 may allow AI agent 402 to perform searches (e.g., web searches, searches within a given application or database, etc.), send control commands, or perform other actions, as needed.

In various implementations, AI agent 402 may also be part of an agentic system whereby multiple AI agents interact with one another to formulate a response to an input request. Indeed, the tools, models, etc. available to any given agent may differ across the agentic system. Consequently, different agents may have different capabilities and specialties. Thus, in some implementations, AI agent 402 may also interact with other agent 408, to aid in formulating a final response to its input request. Typically, other agent 408 is executed by a different device than that of the device executing AI agent 402, meaning that AI agent 402 and other agent 408 may communicate via a computer network. In other implementations, though, both agents may be executed by the same device, in further implementations.

For instance, assume that other agent 408 uses a model that has be specialized using knowledge about computer networks and interfaces with tools capable of interacting with a computer network (e.g., to retrieve information, make configuration changes, etc.). Now, assume that the user of user interface 404 issues a query to AI agent 402 asking why the performance of their videoconferencing application is poor. Further, assume that AI agent 402 uses a model that has been specialized on knowledge about the videoconferencing application and able to interact with that application via tools 406. If its initial assessment of the operation of the videoconferencing application is that everything appears to be performing well at the server level, AI agent 402 may then issue a request to other agent 408, to see whether the root cause of the poor performance is the computer network itself.

In some implementations, AI agent 402 may also interact with, or include, a retrieval augmented generation (RAG) system, such as RAG system 410. In general, RAG systems operate by enhancing a prompt for input to a generative model (e.g., an LLM) with additional context. Typically, underlying a RAG system is a dataset of documents or other information that is in a particular domain. For instance, consider the case of AI agent 402 generating a prompt that asks its LLM to make an assessment regarding a computer network. In the case of a general LLM, the LLM may not have specialized knowledge regarding the devices in the network (e.g., command line interface commands, information about the topology of the network, etc.). In such a case, RAG system 410 may modify the prompt, prior to input to the LLM, to provide this additional context, thereby improving the quality of the response and avoiding hallucinations. Typically, a RAG system stores this contextual information in a vector database for quick retrieval using semantic searching.

Indeed, LLMs and other modern AI models are capable of performing a wide variety of tasks. In addition, agentic systems may leverage such models to perform an even larger set of tasks.

However, training an AI model and performing other high-performance computing (HPC) tasks is not straightforward, as network or compute fabric resources are not unlimited. This means that different AI model training and other computing tasks often need to be scheduled, resulting in some of the tasks having to wait for execution. Indeed, recent studies estimate that approximately 33% of the processing time for all AI tasks is attributable to waiting on backend network delays.

Common network implementations for connecting front-end CPU-based networks and backend GPU-based HPC networks to facilitate data transfer and high-performance computing tasks include High-Speed Ethernet, InfiniBand, NVLink, Peripheral Component Interconnect Express (PCIe), and Fibre Channel (FC), among others. When it comes to AI workloads, a front-end network scheduler is typically used to schedule and orchestrate AI-related workloads ranging from model training to inferencing and data processing. This scheduling often entails coordinating various resources and services, managing job queues, and ensuring that the right data and computational resources are available.

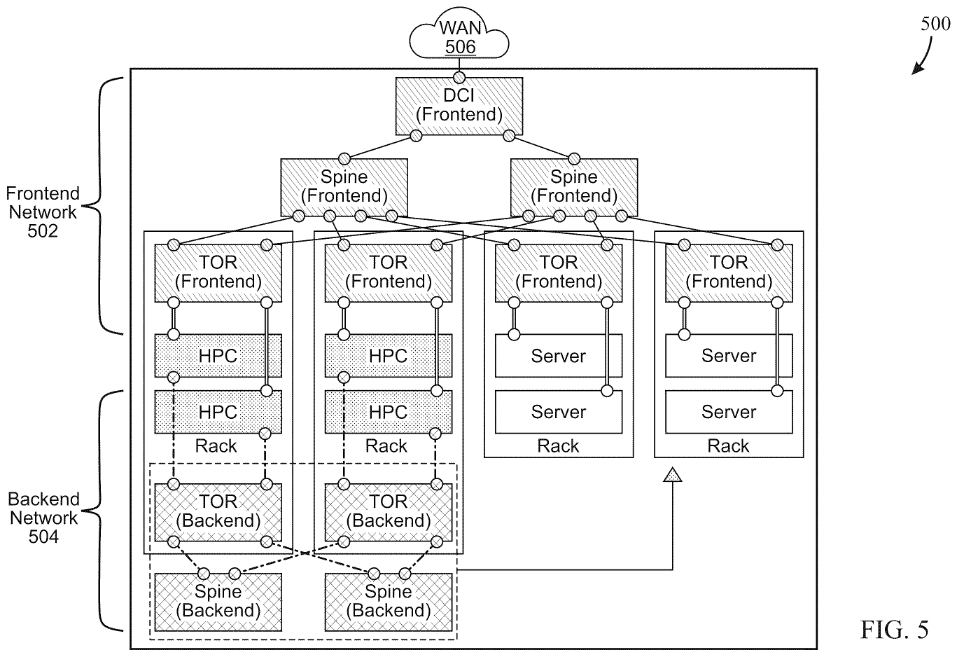

By way of example, FIG. 5 illustrates an example network or compute fabric 500 for performing AI model training and HPC tasks, according to various implementations. As shown, network or compute fabric 500 may include a frontend network 502 and a backend network 504. Network or compute fabric 500 may also be connected to a WAN 506, allowing for remote access.

For instance, frontend network 502 may include various components such as a data center interconnect (DCI), any number of frontend spines, a plurality of top-of-rack (TOR) switches, etc. Likewise, backend network 504 may include HPC clusters, servers, its own backend TOR switches, etc. on the racks, as well as its own backend spines. As would be appreciated, the specific configuration and components of frontend network 502 and backend network 504 may differ as desired.

As noted above, however, end-to-end path performance metrics (e.g., latency, liveliness, loss, jitter, etc.) are often lacking in AI fabrics, such as the fabric shown in FIG. 5.

### Extending End-to-End Measurements to the NIC in an AI Data Center Fabric

The techniques herein introduce a transparent approach to performing end-to-end measurements, including ToR to NIC segments, in a data center fabric.

Illustratively, the techniques described herein may be performed by hardware, software, and/or firmware, such through execution of segment routing process 247, AI process 248, and/or measurement process 249, which may include computer executable instructions executed by the processor 220 (or independent processor of interfaces 210) to perform functions relating to the techniques described herein.

Specifically, according to various implementations, a first device in a network fabric generates a probe packet to probe a particular path in the network fabric between the first device and a second device. The first device adds, based on the particular path, a list of segment routing identifiers to the probe packet that includes segment routing identifiers from the first device to the second device and from the second device back to the first device. The first device sends the probe packet with the list of segment routing identifiers towards the second device. The first device uses the probe packet sent via the particular path to determine one or more performance metrics for the particular path.

Operationally, in various implementations, the techniques herein introduce an approach to deliver the performance measurements for the top-of-rack (ToR) to network interface controller (NIC) segment for purposes of providing full End-to-End measurements. In some instances, the techniques herein may leverage Integrated Performance Measurement (IPM) by Cisco Systems, Inc., or another suitable mechanism, with SRv6 uSID capabilities.

More specifically, in various implementations, the techniques herein may operate as follows:
The ToR is configured with IPM session (Session_S):
   SA=ToR (self)
   DA=ToR (self)
   SRv6 SID List=SID_X
The ToR is configured with SID_X which is bound to following parameters:
   SRv6 uA behavior
   The interface connecting to the NIC
   The SRv6 USD (Ultimate SID Decapsulation) flavor
The ToR generates IPM probe packets: Outer IPv6 header+IP+UDP+Two-Way Active Measurement Protocol (TWAMP)
   The destination address (DA) of the Outer IPv6 header=SID_X
   The packets are timestamped
The IPM Probe packet matches the SID_X and hence:
   The outer IPv6 header is removed, and the packet is pushed on the interface towards the NIC
   Packet on the wire is IP+UDP+TWAMP where IP. SA=ToR and IP.DA=ToR
The NIC forwards the packet back to the ToR based on IP. DA=ToR
Packets received by ToR with SA and DA matches Session_S
Session_S process the packet and records delay.

As would be appreciated, this approach is transparent to the NIC. Indeed, it simply forwards the packet based on the destination address, without NIC dependency.

Also as noted above, the measurement of path performance metrics is important in an AI or HPC fabric, such as the fabric shown in FIG. 5, to characterize the quality/health of all available paths. Such performance metrics include, for instance, latency, liveliness, loss, and jitter. However, measuring such metrics can be challenging in many deployments, as there are typically many Equal-Cost Multipath (ECMP) paths from one fabric edge to the other fabric edge being top-of-rack (ToR)-to-ToR or network interface controller (NIC)-to-NIC.

Per-ECMP path measurements can be valuable for several reasons: 1.) to report per-ECMP Path measurement to the customers/user of the fabric, and 2.) to use the per-ECMP Path measurement as feedback for AI networking solutions that does deterministic place placement of graphics processing unit (GPU)-to-GPU flows over a pre-computed path.

One approach to performing per-ECMP path measurements is to pre-compute an entropy value (e.g., flow label) for each path and use this flow label in the probes of the measurement. However, doing so also requires full knowledge of the hash function of each device on the path, which is not always available. In addition, this approach does not work exactly when it is needed to work. Indeed, once one link fails, the hash changes as the number of the ECMP group changes.

### Deterministic Per-path Measurements in a Data Center Fabric

The techniques introduced herein further allow for per-ECMP path measurements in a data center fabric that can apply to any AI or HPC fabric, without pre-computing hashes/entropy values.

Operationally, in various implementations, the techniques herein allow for per-path ECMP measurements in part by detection whether any path has a failing link. In various implementations, the techniques herein leverage SRv6 to steer traffic over a given ECMP path. More specifically:
The system allocates an SRv6 uA behavior to each interface in the fabric.
The system then determines the network topology that includes the uA SIDs assigned to the interfaces.
For each ToR-to-ToR path, the system then computes:
   The SRv6 segment identifier (SID) list for each ECMP path.
   The SID list includes a sequence of uA SIDs (i.e., List of interfaces) that steers the traffic from ToR-to-ToR over a given ECMP.
The system then configures at each ToR a set Integrated Performance Measurement (IPM) session, or other session identifier, equal to the set of ECMP paths.
   Each session uses one the computed SID lists.
The SID list used by the IPM measurement sessions are the same used to place GPU-to-GPU over a given ECMP path
Each IPM session reports per-ECMP path measurement
If an issue is detected (e.g., latency) on a given Path (i.e., IPM session), the

GPU-to-GPU flow using this ECMP path is moved to another ECMP path.
If a link/node fails, the IPM session that a SID using this link/node will detect the issue. For instance, a liveness issue may be detected if no probes are received over this path for a given timer (e.g., three consecutive probes).

As would be appreciated, the above approach can be applied in many AI and HPC fabrics today.

Additionally, in fabrics such as the one shown in FIG. 5, a one-way delay measurement has several advantages over inferring the one-way delay from a two-way delay. In the latter approach, the one-way delay is computed as the Round Trip Time (RTT) divided by two (RTT/2). In the context of ToR-to-ToR measurements, there are many Equal-Cost Multipath (ECMP) paths. Using two-way delay techniques has no guarantee that the forward path is the same as return path. Hence, the RTT/2 metric is not accurate. In addition, relying on two-way delay measurements is also susceptible to return path issues. Even in cases where the forward and return paths are the same, the RTT/2 (two-way) approach cannot distinguish whether an issue is on the forward path or on the return path.

In the context of ToR-to-NIC measurements, the two-way measurement (RTT) also includes downstream buffering at ToR (ToR-to-NIC) “DownBuffering”, 2*Link delay, and upstream buffering at the ToR (NIC-to-ToR) “UPBuffering.” Since the downstream buffering at the ToR is not the same as the upstream buffering at the ToR, making the RTT/2 metric inaccurate with respect to a singular direction

### Deriving One-way Measurement From TOR-to-NIC and NIC-to-TOR

The techniques introduced herein are further able to determine one-way measurements in data center fabrics, such as top-of-rack (ToR) to network interface controller (NIC) paths and NIC-to-ToR paths.

Operationally, techniques herein allow for the derivation of the one-way delay measurements for both ToR-to-NIC paths as well as for NIC-to-ToR paths. Here, the techniques herein rely on the following equations:

$$One - way delay ( ToR - to - NIC ) = DownBuffering + Link delay \qquad Equation 1$$

$$One - way delay ( NIC - to - ToR ) = UPBuffering + Link delay \qquad Equation 2$$

To compute the three unknown values (DownBuffering, UPBuffering, Link delay) the techniques herein may send three different probes from the ToR to NIC, which are reflected by the NIC back to the ToR. In various implementations, these probes may have the following properties:
Probe1: uses the best effort queue both downstream and upstream. This probe is used to measure RTT1=DownBuffering+UPBuffering+2*Link delay.
Probe2: uses the priority queue downstream and best effort queue upstream. This probe is used to measure RTT2=UPBuffering+2*Link delay.
Probe3: uses the best effort queue downstream and priority queue upstream. This probe is used to measure RTT3=DownBuffering+2*Link delay.

Using these RTT values, the techniques herein can then compute the three unknown values (DownBuffering, UPBuffering, Link delay) as follows:

$$DownBuffering = RTT 1 - RTT 2$$

$$UPBuffering = RTT 1 - RTT 3$$

$$Link delay = ( RTT 2 - UPBuffering ) / 2$$

The techniques herein may then use the computed values (DownBuffering, UPBuffering, Link delay) to solve Equation 1 and Equation 2 above, to compute the one-way delay for ToR-to-NIC and NIC-to-TOR.

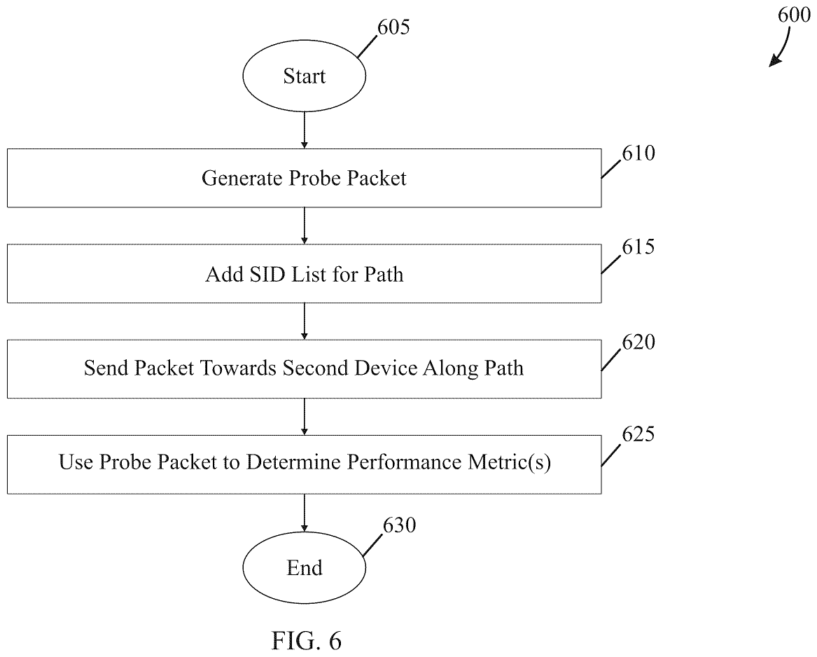

FIG. 6 illustrates an example simplified procedure for extending end-to-end measurements to the network interface controller (NIC) in an AI data center fabric, in accordance with one or more implementations described herein. For example, a non-generic, specifically configured device (e.g., device 200), may perform procedure 600 (e.g., a method) by executing stored instructions (e.g., segment routing process 247, AI process 248, and/or measurement process 249). The procedure 600 may start at step 605, and continues to step 610, where, as described in greater detail above, the device (e.g., a controller, server, NIC, TOR, etc.), acting as a first device, may generate a probe packet to probe a particular path in the network fabric between the first device and a second device. In some implementations, the first device is a top-of-rack (ToR) device and the second device is network interface card (NIC). In other implementations, the first device is a NIC and the second device is a ToR device. In one implementation, the probe packet includes a Two-Way Active Measurement Protocol (TWAMP) header. In a further implementation, the probe packet also includes a User Datagram Protocol (UDP) header.

At step 615, as detailed above, the first device adds, based on the particular path, a list of segment routing identifiers to the probe packet that includes segment routing identifiers from the first device to the second device and from the second device back to the first device. In some implementations, the first device adds the list of segment routing identifiers to a destination address in outer Internet Protocol header of the probe packet. In a further implementation, the probe packet includes an inner Internet Protocol header with a destination address set to that of the first device.

At step 620, the first device sends the probe packet with the list of segment routing identifiers towards the second device, as described in greater detail above. In some instances, the second device forwards the probe packet back towards the first device based on the destination address of the inner Internet Protocol header. In one implementation, the outer Internet Protocol header is stripped from the probe packet during transit to the second device.

At step 625, as detailed above, the first device uses the probe packet sent via the particular path to determine one or more performance metrics for the particular path. In some implementations, the probe packet includes a timestamp and the first device uses the timestamp to compute a delay metric as one of the one or more performance metrics for the particular path.

Procedure 600 may then end at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that allow for extending end-to-end measurements to the NIC in an AI data center fabric, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method comprising:
generating, by a first device in a network fabric, a probe packet to probe a particular path in the network fabric between the first device and a second device;
adding, by the first device and based on the particular path, a list of segment routing identifiers to the probe packet that includes segment routing identifiers from the first device to the second device and from the second device back to the first device;
sending, by the first device, the probe packet with the list of segment routing identifiers towards the second device; and
using, by the first device, the probe packet sent via the particular path to determine one or more performance metrics for the particular path.

2. The method as in claim 1, wherein the first device is a top-of-rack (ToR) device and the second device is network interface card (NIC).

3. The method as in claim 1, wherein the first device is a network interface card (NIC) and the second device is a top-of-rack (ToR) device.

4. The method as in claim 1, wherein the first device adds the list of segment routing identifiers to a destination address in outer Internet Protocol header of the probe packet.

5. The method as in claim 4, wherein the probe packet includes an inner Internet Protocol header with a destination address set to that of the first device.

6. The method as in claim 5, wherein the second device forwards the probe packet back towards the first device based on the destination address of the inner Internet Protocol header.

7. The method as in claim 5, wherein the outer Internet Protocol header is stripped from the probe packet during transit to the second device.

8. The method as in claim 5, wherein the probe packet includes a Two-Way Active Measurement Protocol (TWAMP) header.

9. The method as in claim 8, wherein the probe packet includes a User Datagram Protocol (UDP) header.

10. The method as in claim 1, wherein the probe packet includes a timestamp and the first device uses the timestamp to compute a delay metric as one of the one or more performance metrics for the particular path.

11. An apparatus, comprising:
one or more network interfaces to communicate with a network fabric;
a processor coupled to the one or more network interfaces and configured to execute one or more processes; and
a memory configured to store a process that is executable by the processor, the process when executed configured to:
a probe packet to probe a particular path in the network fabric between the apparatus and a second apparatus;
add, based on the particular path, a list of segment routing identifiers to the probe packet that includes segment routing identifiers from the apparatus to the second apparatus and from the second apparatus back to the apparatus;
send the probe packet with the list of segment routing identifiers towards the second apparatus; and
use the probe packet sent via the particular path to determine one or more performance metrics for the particular path.

12. The apparatus as in claim 11, wherein the apparatus is a top-of-rack (ToR) device and the second apparatus is network interface card (NIC).

13. The apparatus as in claim 11, wherein the apparatus is a network interface card (NIC) and the second apparatus is a top-of-rack (ToR) device.

14. The apparatus as in claim 11, wherein the apparatus adds the list of segment routing identifiers to a destination address in outer Internet Protocol header of the probe packet.

15. The apparatus as in claim 14, wherein the probe packet includes an inner Internet Protocol header with a destination address set to that of the apparatus.

16. The apparatus as in claim 15, wherein the second apparatus forwards the probe packet back towards the apparatus based on the destination address of the inner Internet Protocol header.

17. The apparatus as in claim 15, wherein the outer Internet Protocol header is stripped from the probe packet during transit to the second apparatus.

18. The apparatus as in claim 15, wherein the probe packet includes a Two-Way Active Measurement Protocol (TWAMP) header.

19. The apparatus as in claim 18, wherein the probe packet includes a User Datagram Protocol (UDP) header.

20. A tangible, non-transitory, computer-readable medium storing program instructions that cause a first device in a network fabric to execute a process comprising:
generating, by the first device in the network fabric, a probe packet to probe a particular path in the network fabric between the first device and a second device;
adding, by the first device and based on the particular path, a list of segment routing identifiers to the probe packet that includes segment routing identifiers from the first device to the second device and from the second device back to the first device;
sending, by the first device, the probe packet with the list of segment routing identifiers towards the second device; and
using, by the first device, the probe packet sent via the particular path to determine one or more performance metrics for the particular path.
